(19) United States
(12) Patent Application Publication
(10) Pub. No.: US 2007/0174425 A1
(43) Pub. Date: Jul. 26, 2007

(54) METHOD AND APPARATUS FOR COMMUNICATING WITH A USER USING VIDEO

(76) Inventors: Jean-Philippe Gousse, Montreal (CA); Olivier Edmond, Ville Mont Royal (CA); Arnaud Courbot, Montreal (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/624,885

(22) Filed: Jan. 19, 2007

Related U.S. Application Data
(60) Provisional application No. 60/760,402, filed on Jan. 20, 2006.

(51) Int. Cl. G06F 15/16

(52) U.S. Cl. 709/217

(57) ABSTRACT

A method is disclosed for communicating with at least one user using video via a data network, the method comprising accessing a user web interface, customizing the web interface and communicating with the least one user using video in the customized web interface.

### CROSS-REFERENCE TO RELATED APPLICATIONS

This application claims priority of U.S. provisional patent application No. 60/760,402 that was filed Jan. 20, 2006 and entitled “Method and apparatus for communicating with a user using video”, the specification of which is hereby incorporated by reference.

### TECHNICAL FIELD

This invention relates to the field of communications. More precisely, this invention pertains to a method and apparatus for communicating with a user using video.

### BACKGROUND OF THE INVENTION

With the increase of available bandwidth, communications between individuals have now become easier.

Unfortunately, it is still very difficult to have enjoyable and entertaining communications.

For instance, communicating using a video webcam often requires the installation of an extra software which is required to handle the communication. In the case where the user decides to switch from a computer to another one the extra softwares must be re-installed which is very cumbersome in an environment in which users often access data networks using various means.

Moreover, the user may feel frustrated by the lack of options for communicating using those softwares since they are usually limited in terms of functionalities offered.

There is a need for a method that will overcome at least one of the above-mentioned drawbacks.

### SUMMARY OF THE INVENTION

According to a first aspect of the invention, there is provided a cross-platform web interface for communicating with at least one user using video via a data network, the interface comprising a user configurable videoconferencing module for performing a live video conference with the at least one user when the at least one user is available, a user configurable video file converting module for uploading a local video file and converting the uploaded video file into a video file having a given video file format and a user configurable video email module for sending a link of the converted video file to the at least one user when the at least one user is not available.

According to another aspect of the invention, there is provided a method for communicating with at least one user using video via a data network, the method comprising accessing a user web interface, customizing the web interface and communicating with the least one user using video in the customized web interface.

### BRIEF DESCRIPTION OF THE DRAWINGS

Further features and advantages of the present invention will become apparent from the following detailed description, taken in combination with the appended drawings, in which:

FIG. 1 is a block diagram of one embodiment of a system for performing a communication with at least one selected user using video, the system comprises a server, a plurality of client units and a data network;

FIG. 2 is a flow chart which shows how to communicate with video with at least one selected user according to one embodiment; according to a first step a website is accessed, according to a second step an account is created or accessed, according to a third step a web interface is customized and according to a fourth step a communication is performed using video;

FIG. 3 is a flow chart which shows one embodiment for performing a communication with video, according to a first step a video file is provided, according to a second step a video message is generated and according to a third step the generated video message is provided;

FIG. 4a is a flow chart which shows how the generated video message is provided in one embodiment; in this embodiment, the video message is sent to at least one recipient;

FIG. 4b is a flow chart which shows how the generated video message is provided in one embodiment; in this embodiment, the generated video message is posted on a website;

FIG. 5 is a flow chart which shows another embodiment for performing a communication with video, according to a first step at least one user is invited and according to a second step a video conference is performed with the invited at least one user;

FIG. 6 is a block diagram which shows how to provide a video message;

FIG. 7 is a screenshot of an embodiment of a public user webspace;

FIG. 8 is a screenshot of an embodiment of a “home” section of a private user webspace displayed to a given user;

FIG. 9 is a screenshot of an embodiment of the “manage videos” section of a private user webspace displayed to a given user;

FIG. 10 is a screenshot of an embodiment of the “webspace customization” section of a private user webspace; the screenshot is showing the option of selecting between “HTML”, “TEXT”, “AD”, “IMAGE” and “SWF” for performing the “webspace customization”; in this case, the “image” is selected;

FIG. 11 is a screenshot of an embodiment of a list of images available for customization and displayed in the “webspace customization” section of a private user webspace displayed to a given user;

FIG. 12 is a screenshot of an embodiment of a menu for selecting and sending a file to be used for customization and displayed in the “webspace customization” section of a private user webspace displayed to a given user;

FIG. 13 is a screenshot of another embodiment of the “webspace customization” section of a private user webspace displayed to a given user in which an image is manipulated;

FIG. 14 is a screenshot of another embodiment of the “webspace customization” section of a private user webspace displayed to a given user in which an image may be captured, selected and provided on the webspace;

FIG. 15 is a screenshot of another embodiment of the “webspace customization” section of a private user webspace displayed to a given user in which the layout of the webspace is divided into a plurality of “zones” banners, each of which may be modified interactively by the user performing the customization;

FIG. 16 is a screenshot of an embodiment of the “email skin layout” section of a private user webspace displayed to a given user in which a customization layout of an email may be edited by the user performing the customization;

FIG. 17 is a screenshot of an embodiment of a “send a video” section of a private user webspace displayed to a given user;

FIG. 18 is a screenshot of an embodiment of an “uploading and sending a video” section of a private user webspace displayed to a given user for uploading a video, generating and sending a video message in a customized web interface;

FIG. 19 is a screenshot of an embodiment of the “video chat” section of a private user webspace used for performing a video chat between a plurality of users in a customized web interface;

FIG. 20 is a screenshot of an embodiment of the “organizing contacts” section of a private user webspace displaying a menu for performing a management of the contacts of the user in a customized web interface;

FIG. 21 is a flow chart which shows another embodiment for performing a communication with video; in this embodiment a video broadcast is performed;

FIG. 22 is a screenshot of an embodiment of the “video broadcast” section of a private user webspace used for performing a video broadcast with a plurality of users in a customized web interface; and

FIG. 23 is a screenshot of an embodiment of a public user webspace used for accessing a video broadcast.

It will be noted that throughout the appended drawings, like features are identified by like reference numerals.

### DETAILED DESCRIPTION OF THE PREFERRED EMBODIMENT

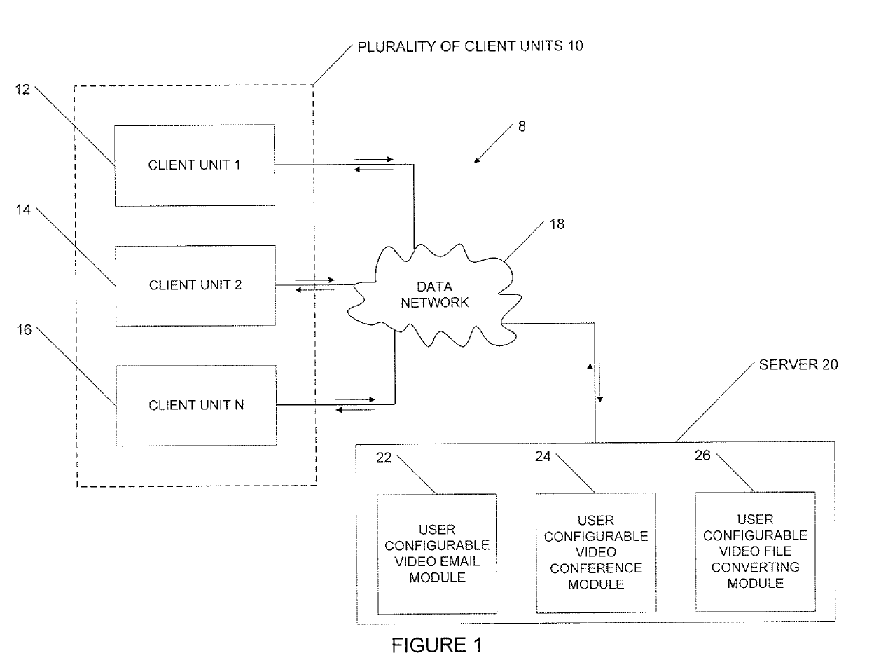

Now referring to FIG. 1, there is shown a system 8 for performing a communication with at least one selected user using video. The system 8 comprises a plurality of client units 10, a data network 18 and a server 20.

The plurality of client units 10 comprises client unit 1 12, client unit 2 14 and client unit N 16. It will be appreciated by the skilled addressee that a client unit is used by a user to access the system 8 via the data network 18.

The client unit may comprise any type of processing units. In one embodiment, the client unit is selected from a group consisting of laptop computers, mobile computers, desktop computers or the like. It will be further appreciated that a client unit may comprise in one embodiment a video data providing unit, not shown in FIG. 1, such as for instance a video camera (also referred to as a webcam) operatively connected to the processing unit of the client unit. It will be appreciated by the skilled addressee that the client unit further comprises a communication interface to enable a connection with the data network 18.

The data network 18 may be at least one of a local area network (LAN), a metropolitan area network (MAN) and a wide area network (WAN). In one embodiment, the data network 18 comprises the Internet. As explained above, each client unit of the plurality of client units 10 is operatively connected to the data network 18.

The server 20 is connected to the data network 18. The server 20 comprises a user configurable video email module 22, a user configurable video conference module 24 and a user configurable video file converting module 26. The server 20 is adapted to provide a cross-platform web interface.

It will be appreciated that the server 20 operates in one embodiment with Flash media server 2, Flashcom server, Open source flash server or any communication server using the flashplayer plugin for client. The skilled addressee will further appreciate that PHP, databases, flash remoting amfphp, mySQL server, Windows and Linux Web Server are used. Preferably, the server 20 is running Unix.

Each client unit of the plurality of client units 10 accesses the server 20 via the data network 18.

As further explained below, the server 20 provides a plurality of services to the user via a corresponding client unit. In fact, the server 20 is adapted to provide a cross-platform web interface to each user. The skilled addressee will appreciate that providing a cross-platform web interface is of great advantage as it enables a large number of users to communicate with the server 20. In one embodiment, the web browser comprises the Flash Plugins version 7.0 installed. Alternatively, the server 20 is accessed by the user via a standalone Flash application running on a corresponding client unit.

More precisely, the cross-platform web interface provided by the server 20 to the plurality of client units 10 comprises a user configurable video conferencing module 24 for performing a live video conference between at least two users of the plurality of clients units 10. It will be appreciated that in one embodiment, the video conference may be a video broadcast to a plurality of users.

The cross-platform web interface further comprises a user configurable video file converting module 26 for enabling a user of a client unit to convert a video file from a video format to a given file format suitable for the server 20. In one embodiment, video files having the .AVI, the .MOV, the .MPG, the .WMV formats may be converted into the .FLV or SWF (Flash video) format by the video file converting module 26.

The cross-platform web interface further comprises a user configurable video email module 22 for creating and delivering a video message as further explained below.

As explained further below, it will be appreciated that the web interface of the cross-platform web interface may be fully customized.

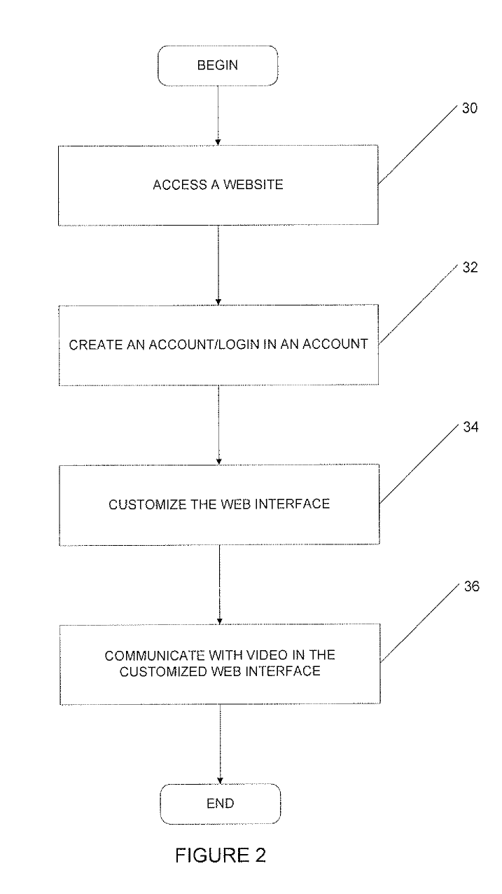

Now referring to FIG. 2 and according to step 30, a website is accessed. The website is accessed by a user via a client unit connected to the data network 18. Still in one embodiment, the website is accessed using an URL entered in a web browser running on the client unit. Alternatively, the website is accessed by a standalone application.

The website accessed is provided by the server 20 in one embodiment.

According to step 32, an account is created by a user on the accessed website. It will be appreciated that the account may be created using various schemes. For instance, in one embodiment a fee may be required to create the website while in another embodiment, no fee is required to create the account. In the case where the account is already created the user accessing the website may login to his existing account. It will be appreciated by the skilled addressee that when the user logs in, the user may access his private user webspace. In the case where no login is performed only a public user webspace may be accessed.

According to step 34, a web interface is customized by the user. It will be appreciated that the web interface is customized in the private user webspace of the user as explained further below.

According to step 36, a communication is performed with video. The communication is performed in the customized web interface.

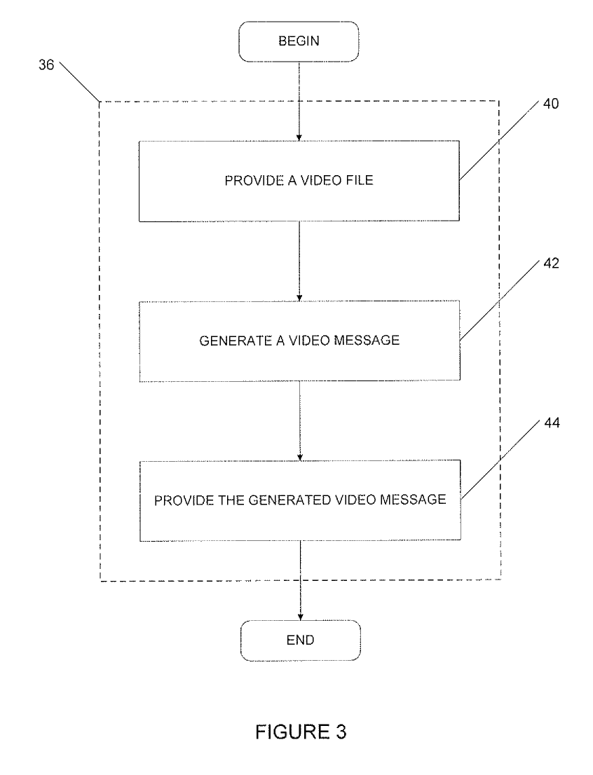

Now referring to FIG. 3, there is shown one embodiment for performing a communication with video.

According to step 40, a video file is provided. In one embodiment, the video file is provided by the user using the video data providing unit operatively connected to the client unit. The skilled addressee will appreciate that the video file may comprise a video of the user operating the video data providing unit. Alternatively, the video file may comprise any other type of video generated by the video providing device. It will be appreciated that the video file provided has a given format suitable with the video format used by the server 20. If necessary, a video file format conversion is performed by the server 20 upon receipt of the video file.

In an alternative embodiment, a video file may be uploaded and converted into a suitable format using the video file converting module 26. The skilled addressee will appreciate that this is of great advantage for a client unit which does not comprise a video providing device.

According to step 42, a video message is generated. The video message is generated using the provided video file. As explained above, it will be appreciated that the video file used has a given format which is in one embodiment the Flash video format. It will be appreciated that the video message may further comprise a corresponding text message, a title and at least one attachment file. Furthermore, it will be appreciated that the video message may be delivered to either at least one recipient or to an undefined plurality of recipients as explained below and that the video message further comprises an indication of a type of delivery used.

According to step 44, the generated video message is provided.

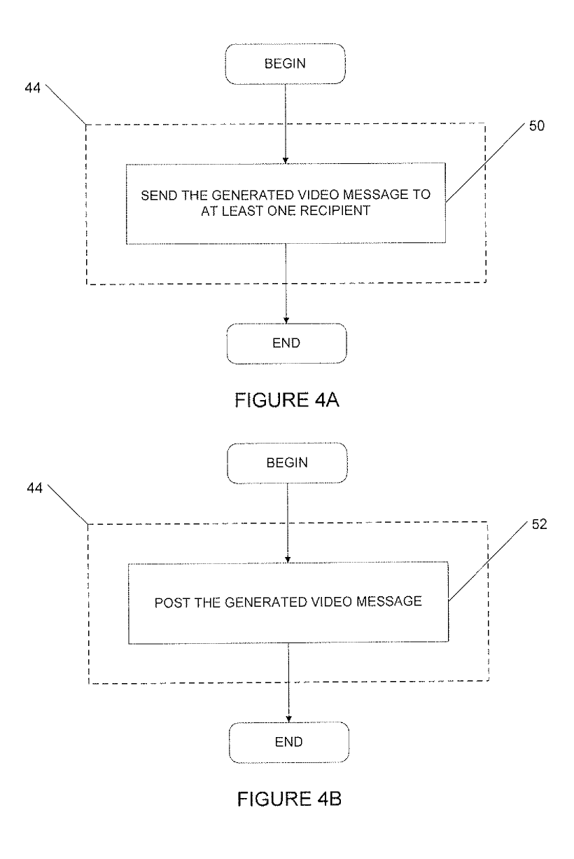

Now referring to FIG. 4a and according to step 50, there is shown one embodiment for providing the generated video message. In this embodiment, the generated video message is provided to at least one recipient listed in the video message. The skilled addressee will appreciate that in such case, the video message is provided to a defined number of addressees. It will be appreciated that the video message may be provided by first delivering a notifying email to each of the at least one recipient and second accessing the video message via a browser for instance. The notifying email may comprise a link to the private webspace hosting the video message. The skilled addressee will appreciate that in one embodiment, the private webspace is also customized. The skilled addressee will appreciate that this avoids many drawbacks associated with the sending of large data files over data networks. Alternatively, the video message may be sent directly to each of the at least one recipient. Also, it will be appreciated that in one embodiment the customization of the private webspace hosting the video message may be programmed to change after a given event such as a predetermined amount of viewing of the video message or a given time for instance. The skilled addressee will appreciate that this is of great advantage since it enables a dynamic customization of the private webspace used by the user for displaying the video message.

Now referring to FIG. 4b there is shown another embodiment for providing the generated video message.

According to step 52, the generated video message is posted. In one embodiment, the generated video message is posted on the public webspace corresponding to the user generating the video message. The skilled addressee will appreciate that the user may advantageously customize his corresponding public webspace. The skilled addressee will appreciate that in such case, the video message may be broadcast to a larger audience than the one with the embodiment disclosed in FIG. 4a. It will be appreciated that the public webspace is hosted by the server 20 in one embodiment.

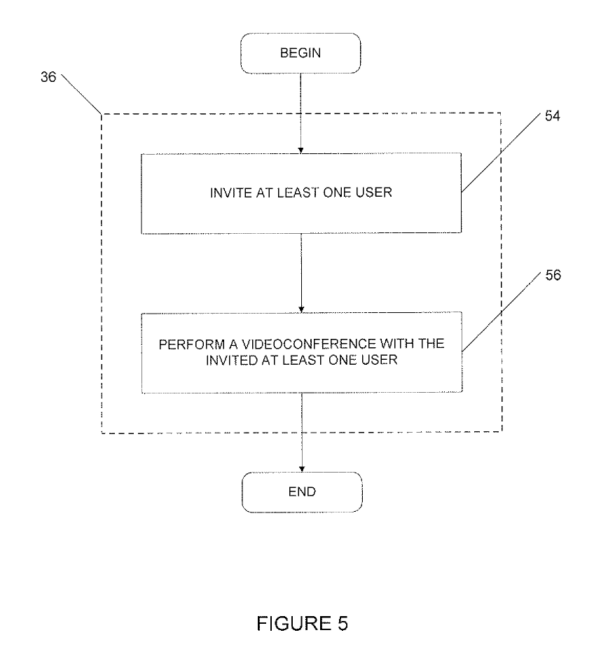

Now referring to FIG. 5, there is shown a further embodiment for performing a communication using video.

According to step 54, at least one user is invited. In one embodiment, the at least one user is invited using an email sent by the user organizing the videoconference. Alternatively, the email is automatically sent by the server 20 and requests the presence of the at least one user. In one embodiment, the email comprises information data related to the videoconference such as a date and a time for performing the videoconference.

According to step 56, a video conference (also referred to as a video chat) is performed with the invited at least one user. It will be appreciated by the skilled addressee that the video conference is performed using the server 20. It will be appreciated that during the video conference it may be possible to switch on/off the audio signal originating from at least of the at least one user.

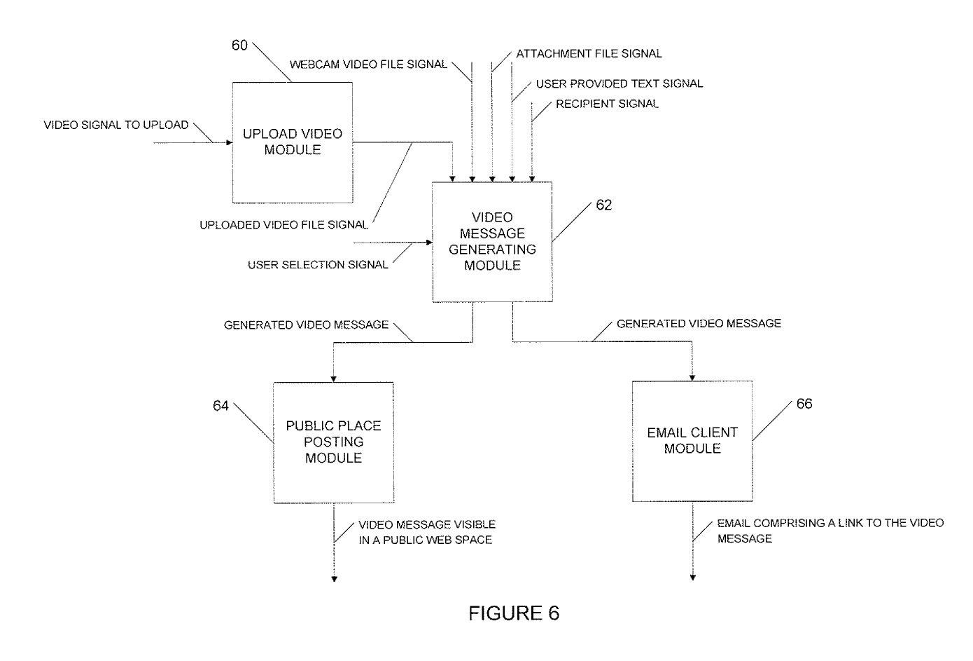

Now referring to FIG. 6, there is shown an embodiment for creating and delivering video messages. In this embodiment, an upload video module 60 is connected to a video message generating module 62. The video message generating module 62 is connected to a public place (public user webspace) posting module 64 and/or to an email client module 66.

The upload video module 60 is used for uploading a video file signal and providing the uploaded video file signal to the video message generating module 62. The video message generating module 62 is used to generate the video message. More precisely, the video message generating module 62 receives a user selection signal, an uploaded video file signal, a video file signal, an attachment file signal, a user provided text signal and a recipient signal.

It will be appreciated that the video message generating module 62 selects at least one of the uploaded video file signal and the provided video file signal. The generated video message signal is provided to the public space posting module 64 which posts the video message in a user public webspace if the user choses the posting option. In the case where the user selects to send the generated video message to a limited number of recipients, the generated video message is provided to an email client module 66 and the email client module 66 generates and sends the video message to at least one recipient. It will be appreciated that in one embodiment the email comprises a link to the video message which may be displayed on a further webspace. The skilled addressee will appreciate that in such embodiment, the size of the video message stays small. Alternatively, a notifying email is sent by the email client module 66 to the at least one recipient. The video message is concurrently posted on a private webspace which may only be accessed by the at least one recipient. In such case, the notifying email comprises a link for accessing the private webspace hosting the video message.

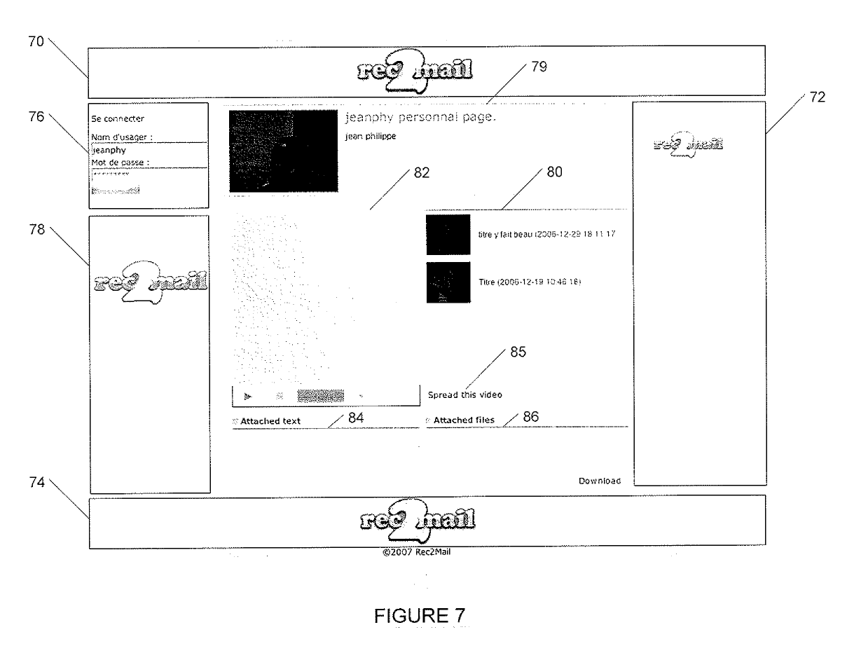

Now referring to FIG. 7, there is a shown an embodiment of a public user webspace.

The public user webspace comprises a top horizontal banner 70, a right vertical banner 72, a bottom horizontal banner 74, a login menu 76, a left vertical banner 78, a middle horizontal banner 79, a video player window 82, a window displaying a plurality of videos to display 80, a window comprising text 84 and a window displaying attached files 86.

It will be appreciated by the skilled addressee that the top horizontal banner 70, the right vertical banner 72, the bottom horizontal banner 74, the central horizontal banner 79 and the left vertical banner 78 may be fully customized as explained below. In one embodiment, at least one of the plurality banners may be customized by a user. Alternatively, at least one of the plurality of banners may be customized by an administrator operating the website.

In one embodiment, at least one of the plurality of banners may be still data while in another embodiment at least one of the plurality of banners may dynamic data. The skilled addressee will further appreciate that the format of the data used in the plurality of banners may be selected from a group consisting of .gif, .jpg, .png, .mov, .swf, .html, php and javascript.

It will be further appreciated that the embodiment of the plurality of banners is exemplary and various alternative embodiments comprising a plurality of banners may be provided.

The video player window 82 is adapted to display a selected video from the window displaying a plurality of videos to display 80. It will be appreciated that each video is part of a given video message. The skilled addressee will appreciate that the window comprising text 84 is adapted to display a text corresponding to the video being displayed in the video player window 82.

Similarly, the window displaying attached files 86 is adapted to display a file corresponding to the video being displayed in the video player window 82.

The skilled addressee will appreciate that the attached file displayed in the window displaying attached files 86 may be downloaded by the user. It will be further appreciated that using “spread this video” button 85, a user may spread a selected video to his corresponding public user webspace.

The login menu 76 is used by a user to login to a private user webspace. In the embodiment disclosed in FIG. 7, the login is performed by providing a login and a corresponding password. The skilled addressee will appreciate that various other embodiments may be used to perform a login.

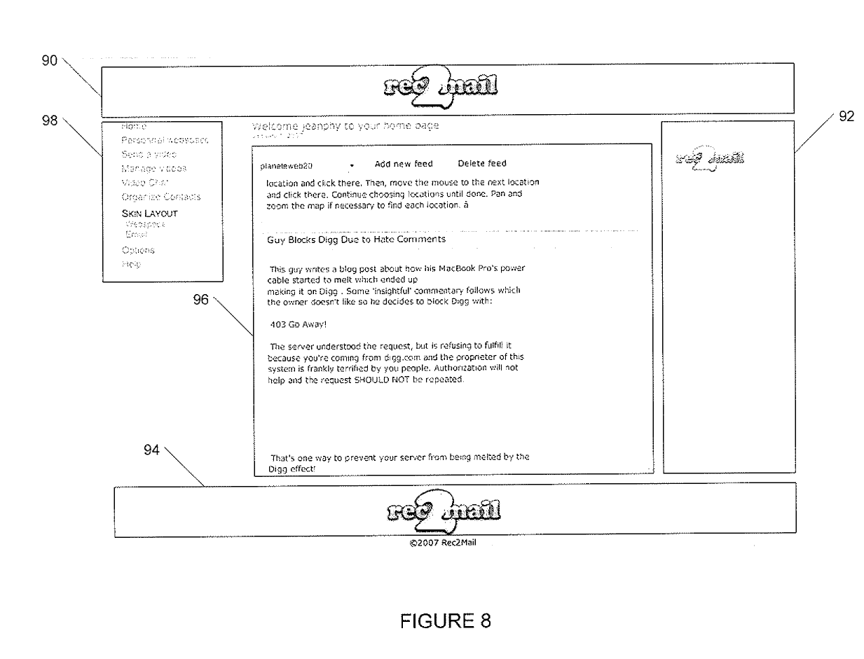

Now referring to FIG. 8, there is shown an embodiment of the home section of a private user webspace.

The skilled addressee will appreciate that the private user webspace is accessed by a user by entering a login and a corresponding password in the login menu 76 displayed in FIG. 7.

Now referring back to FIG. 8, the private user webspace comprises a top horizontal banner 90, a right vertical banner 92, a bottom horizontal banner 94, a main window 96 and a navigation menu 98.

It will be appreciated that the top horizontal banner 90, the right vertical banner 92 and the bottom horizontal banner 94 may be fully customized as explained above. As explained above, the plurality of banners may be customized by a user in one embodiment. Alternatively, the plurality of banners may be customized by the operator of the website.

The skilled addressee will appreciate that the plurality of banners may be advantageously used by the operator of the website to display advertising data. The skilled addressee will further appreciate that the plurality of banners shown in FIG. 8 may be disposed according to another embodiment.

The navigation menu 98 comprises a list of a plurality of the sections which may be accessed by the user. In this embodiment, the navigation menu 98 comprises a link to a “home” section, a link to a “personal webspace” section, a link to a “send a video” section, a link to a “manage videos” section, a link to a “video chat” section, a link to an “organize contacts” section, a link to a “webspace skin layout” section, a link to a “email skin layout” section, a link to a video broadcast section (not shown in the figure), a link to an “options” section and a link to an “help” section.

The main window 96 is used to display data. It will be appreciated that the data to be displayed in the main window 96 is displayed only to the user since FIG. 8 shows an embodiment of the “home” section of a private user webspace. It will be appreciated by the skilled addressee that the main window 96 is used to display customized data which are RSS/Atom feed data in the embodiment disclosed in FIG. 8. The skilled addressee will appreciate the various other type of data may be displayed in the main window 96.

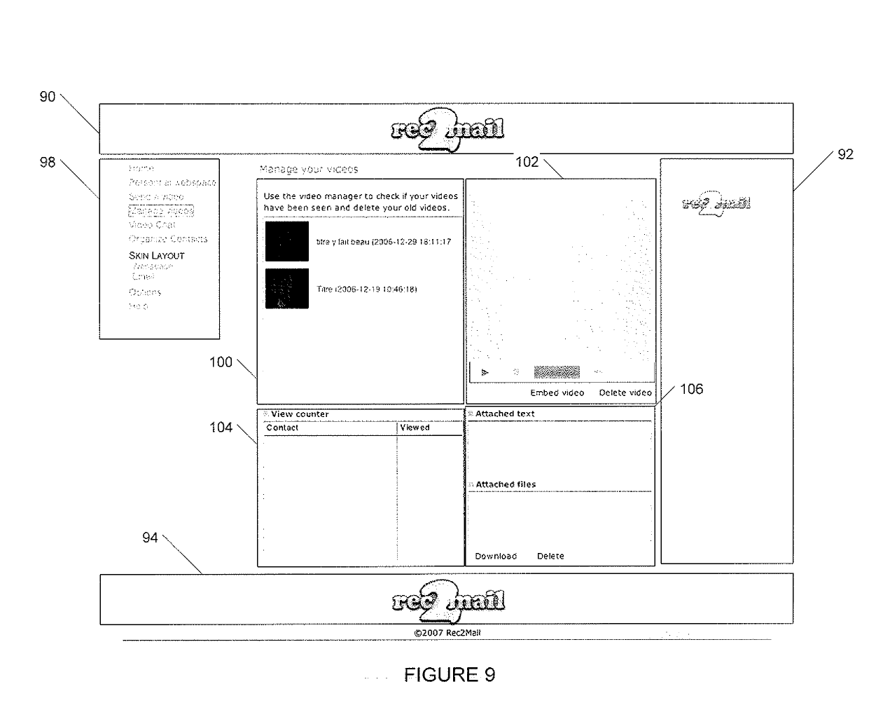

Now referring to FIG. 9, there is shown an embodiment of the “manage videos” section of the navigation menu 98. In this embodiment, the “manage videos” section comprises the top horizontal banner 90, the right vertical banner 92, the bottom horizontal banner 94, the navigation menu 98, a window displaying a plurality of videos to display 100, a video player window 102, a video message view counter window 104 and an attachment data window 106.

The window displaying a plurality of videos to display 100 is used to select a video for viewing and management. The video player window 102 is used to display a selected video of a selected video message. The attachment data window 106 is used to access the attachment data related to a video message selected. The skilled addressee will appreciate that the attachment data comprises in one embodiment at least one attached file and an attached text. It will be further appreciated that at least one of the attachment data may be downloaded or deleted.

The video message view counter window 104 is used by a user to find out if and by who a selected video message has been already viewed. The skilled addressee will appreciate that the “videos management” section is used by the user to control, view, amend or delete at least one of the plurality of video messages created by the user.

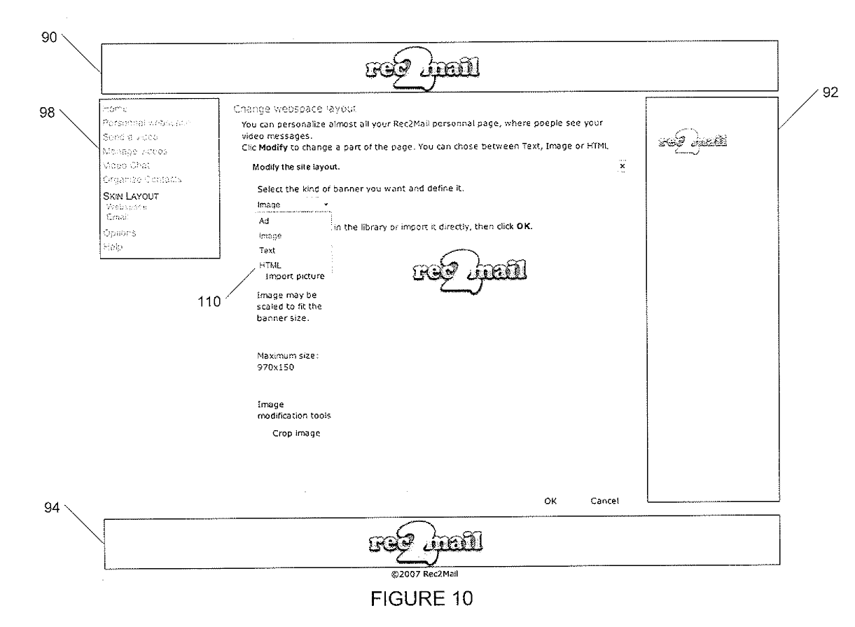

Now referring to FIG. 10, there is shown an embodiment of an image selection menu displayed in the “webspace customization” section of the private user webspace, the “webspace customization” section comprises the top horizontal banner 90, the right vertical banner 92, the bottom horizontal banner 94, the navigation menu 98 and an image selection menu 110.

The image selection menu 110 is used by the user to select a type of banner to be defined and used. In the embodiment disclosed in FIG. 10, the type of banner is selected from a group consisting of ad, image, text and html. The skilled addressee will appreciate that various other types of banners may be provided.

The navigation menu 98 is used by the user to navigate in another section of the private user webspace.

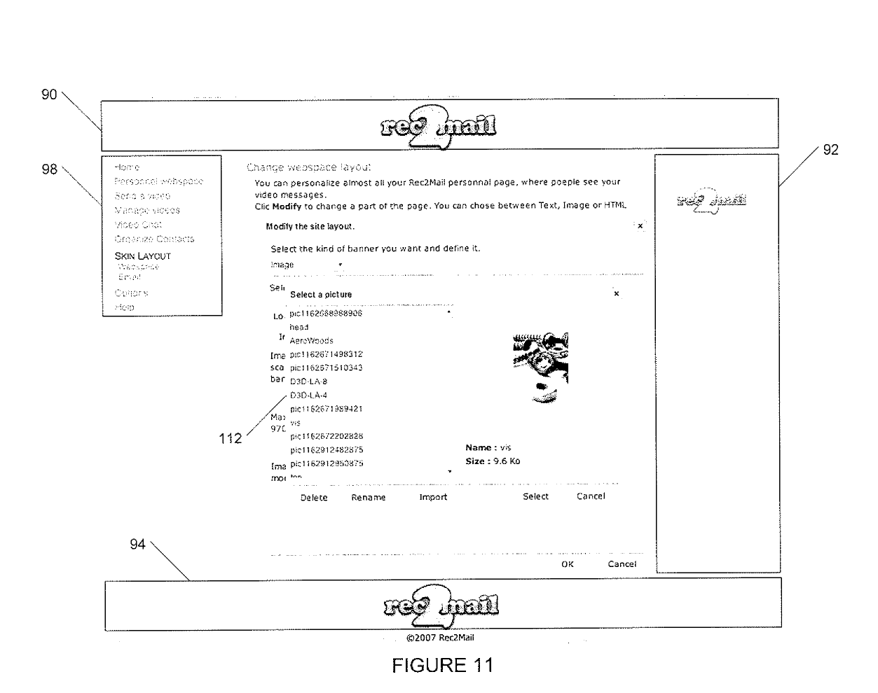

Now referring to FIG. 11, there is shown another embodiment of the “webspace customization” section of the private user webspace in which a list of pictures available to be used for customization is provided.

In this embodiment, the “webspace customization” section comprises the top horizontal banner 90, the right vertical banner 92, the bottom horizontal banner 94, the navigation menu 98 and a scrolling menu 112 for displaying and selecting one of a plurality of images. The skilled addressee will appreciate that the scrolling menu 112 for displaying and selecting one of a plurality of images displays a priority of files available to be used for the customization.

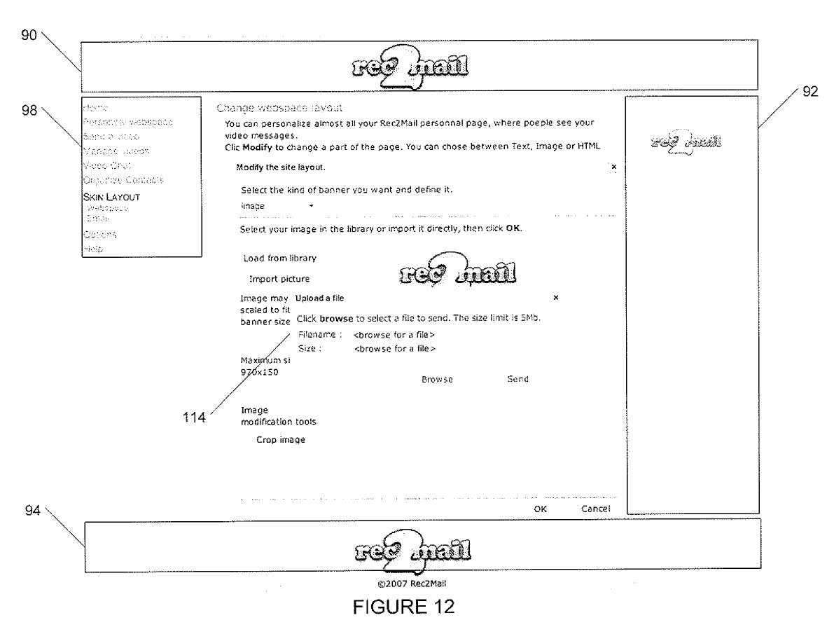

Now referring to FIG. 12 there is shown an embodiment of a menu for selecting and sending a file to be used for performing the customization, the menu being displayed in the “webspace customization” section of the private user webspace. In this embodiment, the “webspace customization” section comprises the top horizontal banner 90, the right vertical banner 92, the bottom horizontal banner 94, the navigation menu 98 and a menu 114 for selecting and sending a file to be used for performing the customization of the plurality of banners. It will be appreciated that the file may be browsed locally and sent to the website.

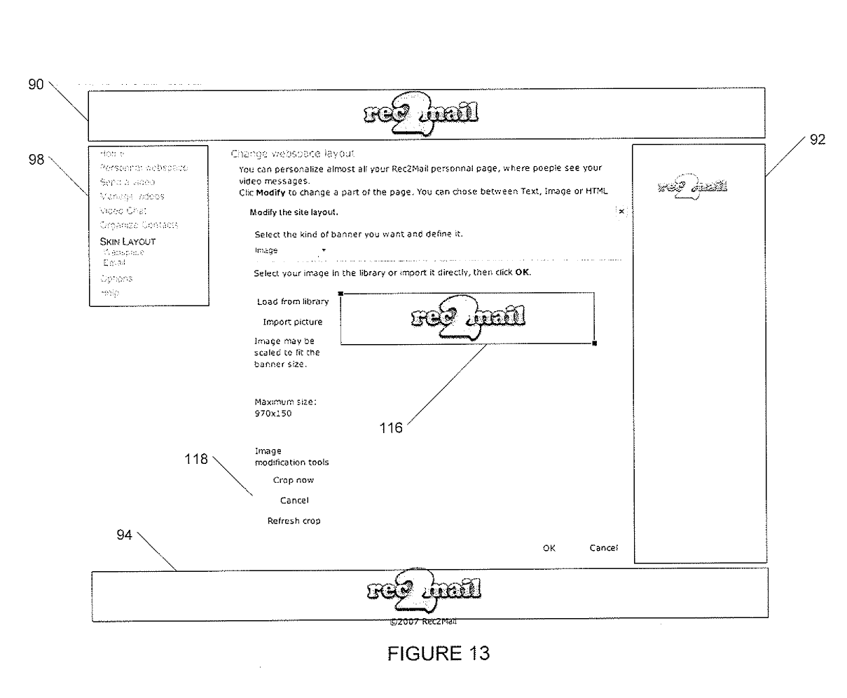

Now referring to FIG. 13, there is shown another embodiment of the “webspace customization” section of the private user webspace. In this embodiment, the “webspace customization” section comprises the top horizontal banner 90, the right vertical banner 92, the bottom horizontal banner 94, a displayed image to be manipulated interactively by the user 116 and an image manipulation menu 118. It will be appreciated by the skilled addressee that an image may be selected and manipulated by the user. In this embodiment, the displayed image 116 is going to be interactively manipulated by the user using the image manipulation menu 118.

The skilled addressee will appreciate that the user may therefore interactively design his own banners while using the website rather than creating the banners offline using another image manipulation software. It will be further appreciated that the manipulation may be performed using various operations which are not listed.

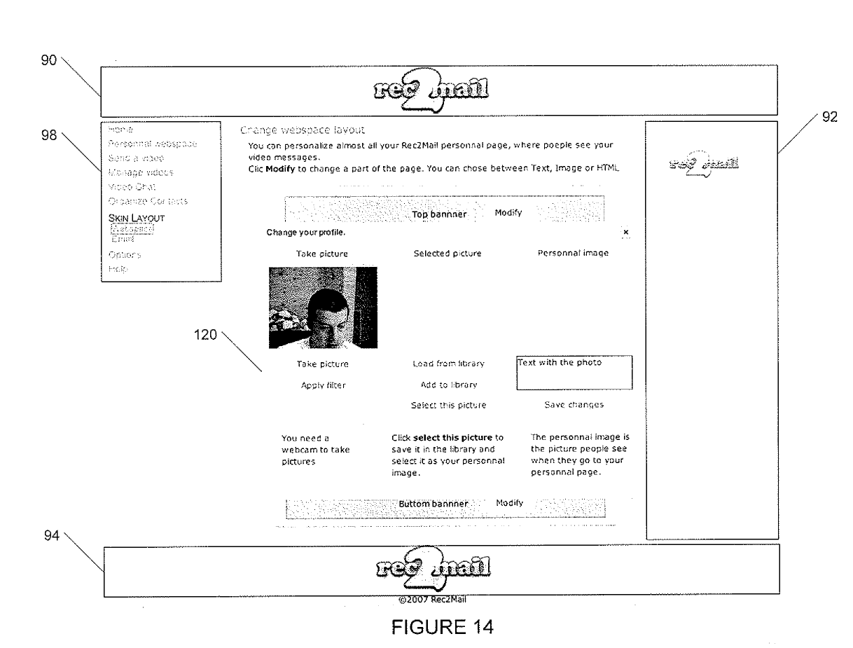

Now referring to FIG. 14, there is shown another embodiment of the “webspace customization” section of the private user webspace in which an image may be captured and manipulated by the user. In this embodiment, the “webspace customization” section comprises the top horizontal banner 90, the right vertical banner 92, the bottom horizontal banner 94, the navigation menu 98 and a profile menu window 120. The profile menu window 120 comprises a picture taken interactively by the user to which a filter may be applied. It will be appreciated that the picture may be loaded from a library alternatively. The picture may also be added to the library. As further shown in FIG. 14, a text may be added to the picture. The picture may be used and displayed in the public user webspace. It will be appreciated by the skilled addressee that the profile menu window 120 shown in FIG. 14 is exemplary and that various other embodiments may be provided.

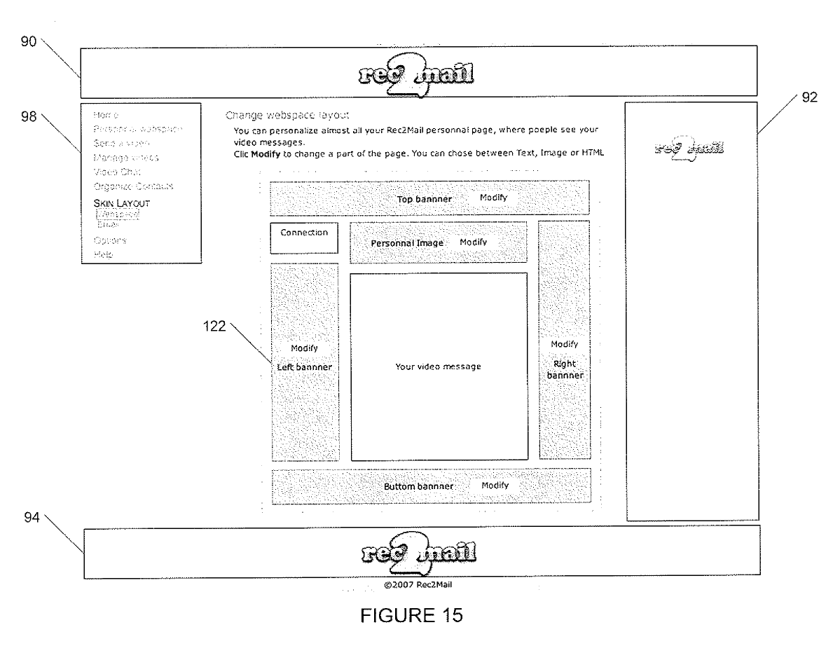

Now referring to FIG. 15, there is shown another embodiment of “webspace customization” section of the private user webspace.

In this embodiment, the “webspace customization” section comprises the top horizontal banner 90, the right vertical banner 92, the bottom horizontal banner 94, the navigation menu 98 and an image 122 identifying an embodiment of a layout for the webspace. The skilled addressee will appreciate that the image 122 identifying an embodiment of a layout for the webspace shows a plurality of banners, each of which may be modified interactively by the user performing the “webspace customization”. The skilled addressee will appreciate that this is of great advantage since it enables the user to provide a plurality of customized data attached to a given video message.

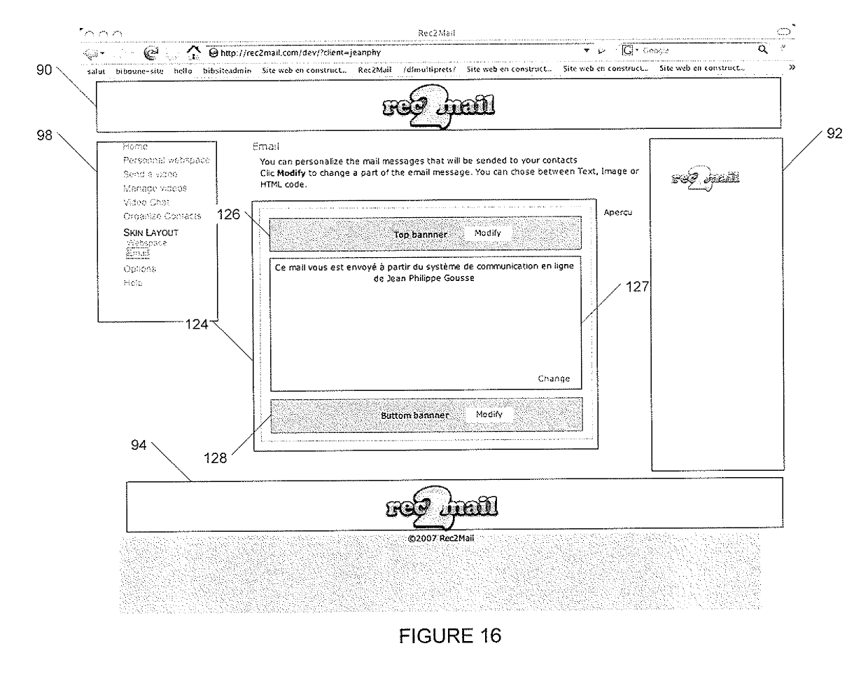

Now referring to FIG. 16, there is shown an embodiment of the “email skin layout” section of the private user webspace. The “email skin layout” section comprises the top horizontal banner 90, the right vertical banner 92, the bottom horizontal banner 94, the navigation menu 98 and a window 124 disclosing a customizable layout of an email.

The window 124 disclosing a customizable layout of an email comprises in this embodiment a top horizontal banner 126, an email text section 127, a bottom horizontal banner 128. The window 124 disclosing a customizable layout of an email is used by the user to interactively customize the layout of an email to be sent for notifying of a video message. It will be appreciated by the skilled addressee that the top horizontal banner 126 as well as the bottom horizontal banner 128 may be modified by the user.

The text section of the layout of the window 124 may be further amended according to a user's choice.

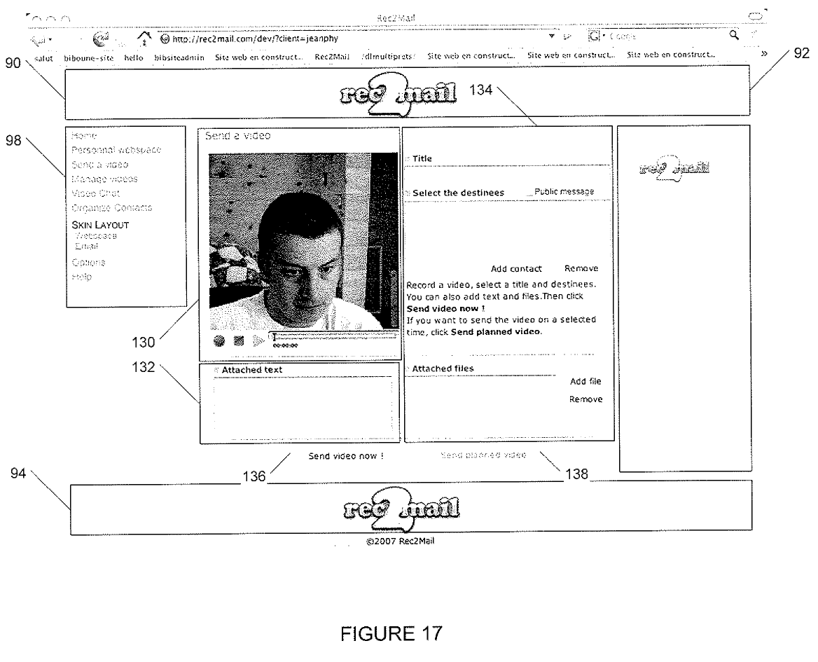

Now referring to FIG. 17, there is shown an embodiment of the “send a video” section of the private user webspace.

In this embodiment, the “send a video” section comprises the top horizontal banner 90, the right vertical banner 92, the bottom horizontal banner 94, the navigation menu 98, a video player window 130, a window 132 comprising text and a window 134 comprising attachment files, at least one recipient and a title for the video message to send.

The video player window 130 is used to “broadcast” record, stop and play a video file. The window 134 comprising text 132 is used to enter a text to be used in the video message to send.

The window 134 is used to enter a title, select at least one recipient for the video message and to add or remove at least one file to be attached to the video message.

The skilled addressee will appreciate that the video message is a combination of and at least one of a title, an attached text and a least one attachment file. It will be further appreciated that, as explained above, the video message may be delivered to a given list of at least one recipient or alternatively the video message may be broadcast to a plurality of users by displaying the video message on the public user webspace. It will be further appreciated that the video message may be sent now by clicking on “send video now” button 136 or alternatively the video message may be sent at a planned time by clicking the “send planned video” button 138.

Sending a video message at a planned time may be of great advantage in the case where the video message must be delivered for a special and scheduled occasion such as an anniversary, or the like.

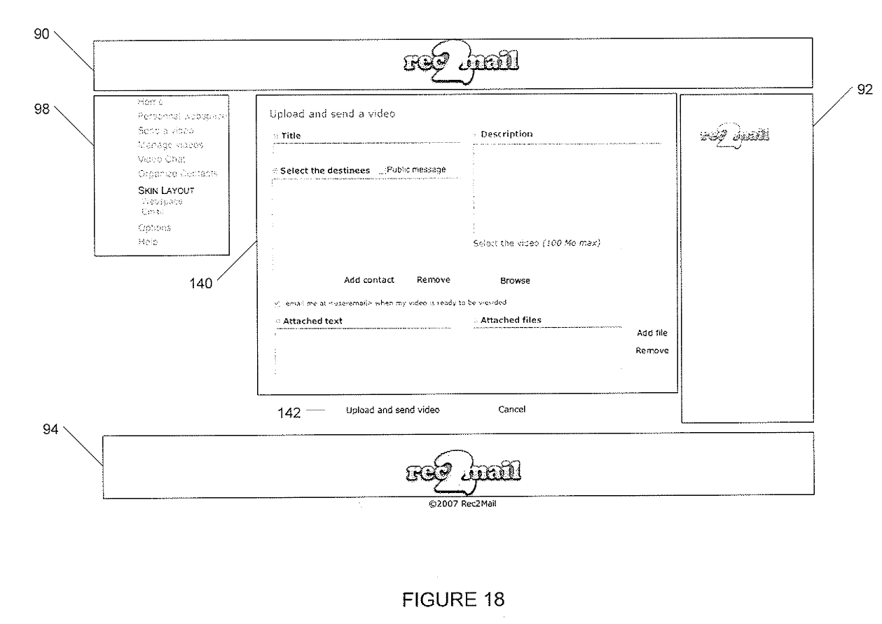

Now referring to FIG. 18, there is shown an embodiment of a “uploading and sending a video” section for uploading and sending a video message in the customized web interface.

In this embodiment, the “uploading and sending a video” section comprises the top horizontal banner 90, the right vertical banner 92, the bottom horizontal banner 94, the navigation menu 98, and a menu 140 for uploading and sending a video to be used in a video message.

The menu 140 for uploading and sending a video to be used in a video message comprises a description section, a text section, a section for adding or removing at least one attached file, a section for adding or removing at least one recipient for the video message, a section for providing a title to the video message, a section for selecting a video to upload and use for generating the video message.

The “uploading and sending a video” section further comprises an “upload and send video” button for uploading a video and sending the video message.

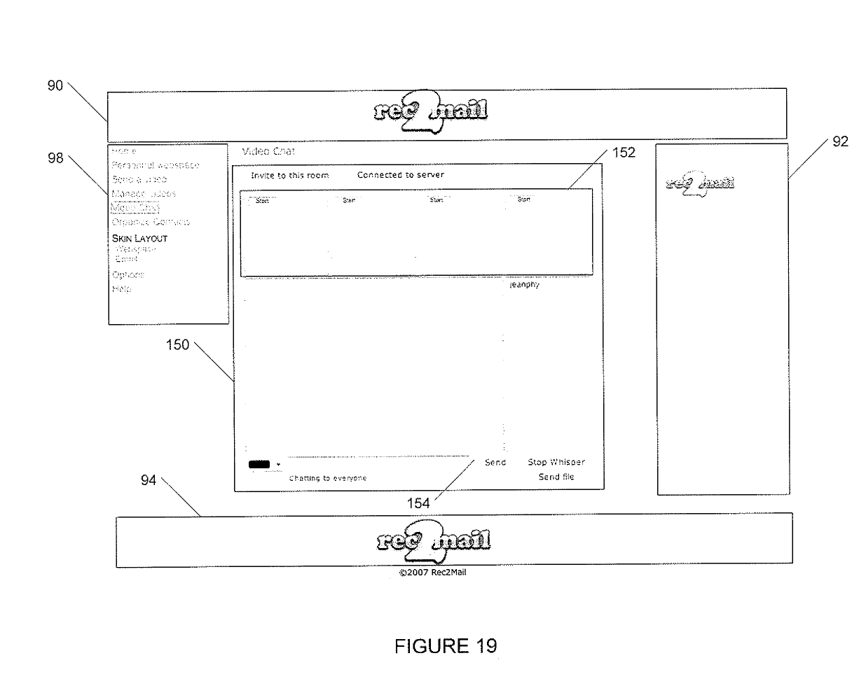

Now referring to FIG. 19, there is shown an embodiment of the “video chat” section of the private user webspace.

The “video chat” section comprises the top horizontal banner 90, the right vertical banner 92, the bottom horizontal banner 94, the navigation menu 98, and a video conference section 150.

The video conference section 150 comprises a plurality of viewing windows 152 and a send button 154. Each of the plurality of viewing windows is used to view interactively an individual participating to the video chat. In the video conference section 150, the user may enter text data which is then provided to all of the at least one individual participating to the video chat. The video conference section 150 also comprises an indication of all of the at least one individual participating to the video chat. It will be appreciated that other type of data, such as binary files, may be sent to the at least one individual participating to the video chat. The skilled addressee will appreciate that various other embodiment of the video conference section lS0 may be provided.

It will be appreciated by the skilled addressee that the “video chat” section displayed in FIG. 19 is used to perform a video chat with four other users.

It will be further appreciated that in one embodiment, a user may select one of three types of status. A first type is “public”, a second type is “present” or active and a third type is “non-active” or “away”. It will be appreciated that the user may see who is online between allowed people such as friends or members of a business group.

In fact, it will be appreciated that if the user status is “public”, every other user connected may contact him. If the user status is “active”, only authorized users may contact the user. If the user status is “non-active”, no other user may contact the user.

It will be further appreciated that a meeting may be planned between a plurality of users for performing a video chat.

The skilled addressee will appreciate that the video chat is performed in the customized web interface which is of great advantage.

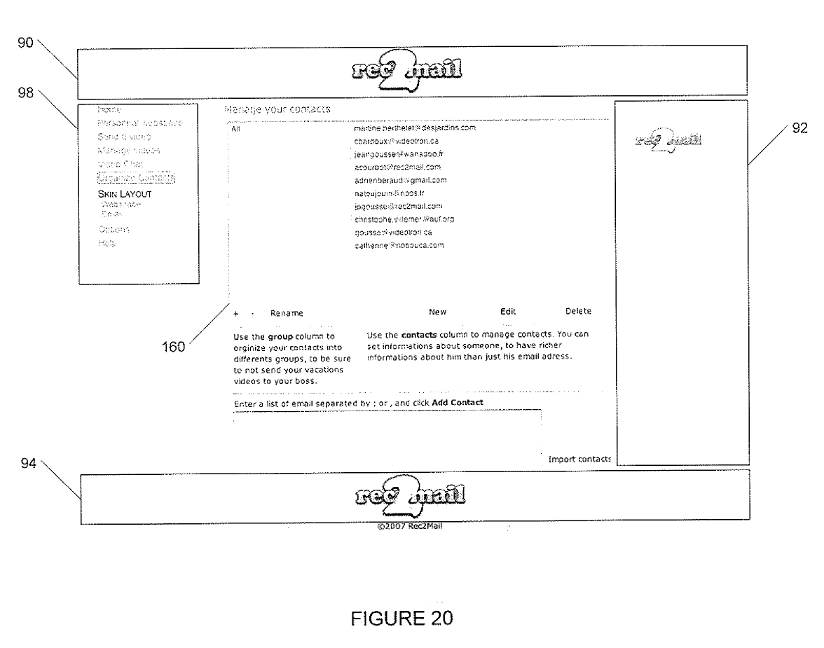

Now referring to FIG. 20, there is shown an embodiment of the “organize contacts” section of the private user webspace.

The “organize contacts” section comprises the top horizontal banner 90, the right vertical banner 92, the bottom horizontal banner 94, the navigation menu 98, and a contact management section 160.

The contact management section 160 comprises a list of a plurality of contacts which may be created edited or deleted. It will be further appreciated that the contact may be imported.

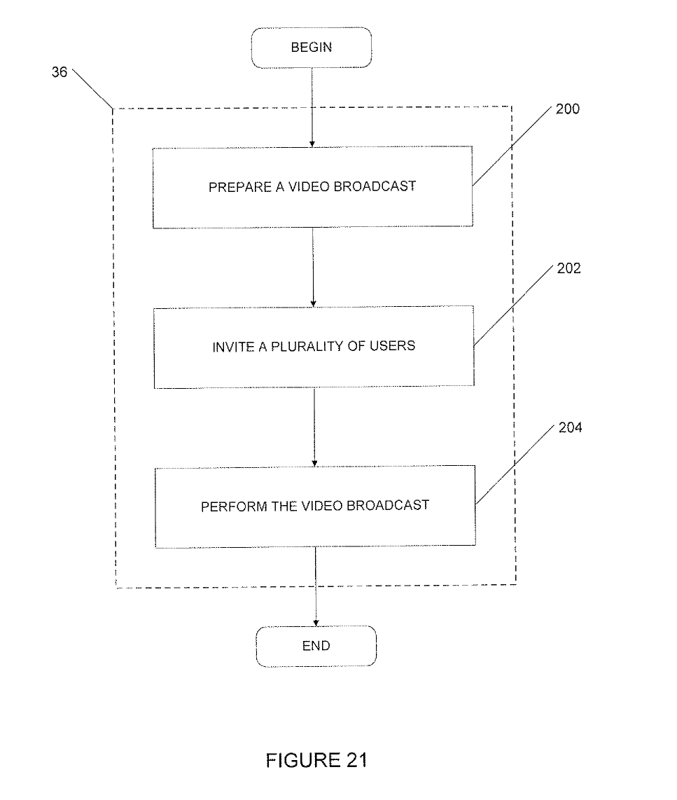

Now referring to FIG. 21, there is shown another embodiment for communicating with video. In this embodiment, a video broadcast is performed to a plurality of users. The video broadcast is performed on a video broadcast webspace which is fully customizable.

According to step 200, a video broadcast is prepared by the user. More precisely, the video broadcast is prepared by the user by accessing a “video broadcast” section of the private user webspace, not shown in the previous figures.

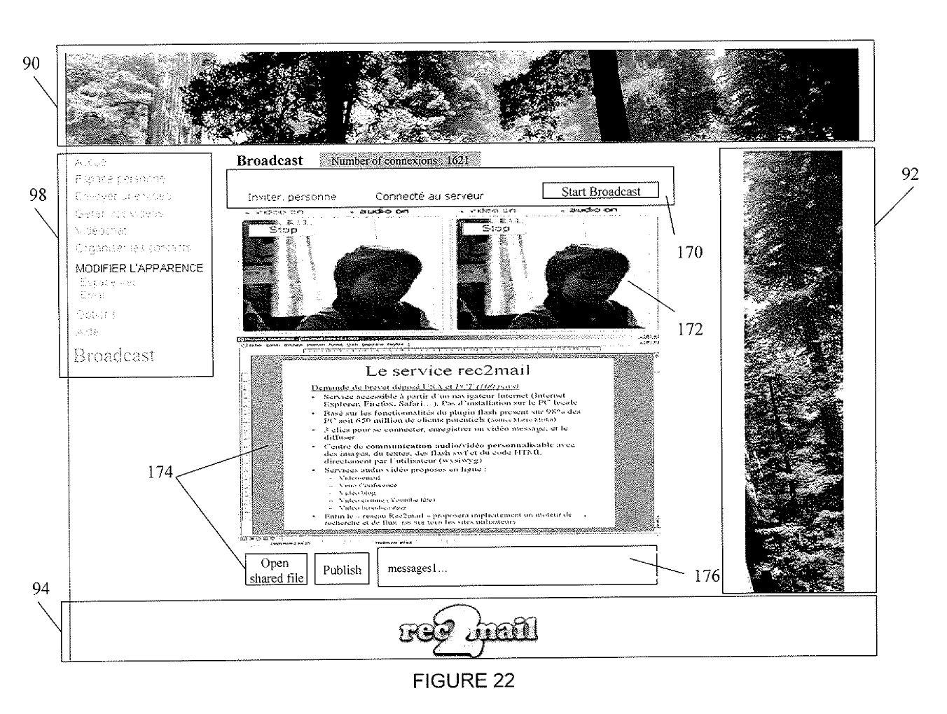

Now referring to FIG. 22, there is shown an embodiment of the “video broadcast” section which comprises the top horizontal banner 90, the right vertical banner 92, the bottom horizontal banner 94, the navigation menu 98 and at least one window for displaying a view of the video broadcast 172, a “start broadcast” button 170, a window displaying feedback received from the users watching the video broadcast 176, a window for launching an application which may be broadcasted along with the video 174. The application may be any type of applications such as a word processing application, a spreadsheet application, a file presentation application or the like. The skilled addressee will appreciate that the application may or may not be broadcast with the video depending on the type of video broadcast. It will be appreciated that in the case where the video broadcast is used for teaching an audience, the broadcast of the application may be advantageously used for illustrating the teaching. The application may be broadcast along with the video by selecting an application to use, a file to open and a corresponding button on the “video broadcast” section to validate the selection.

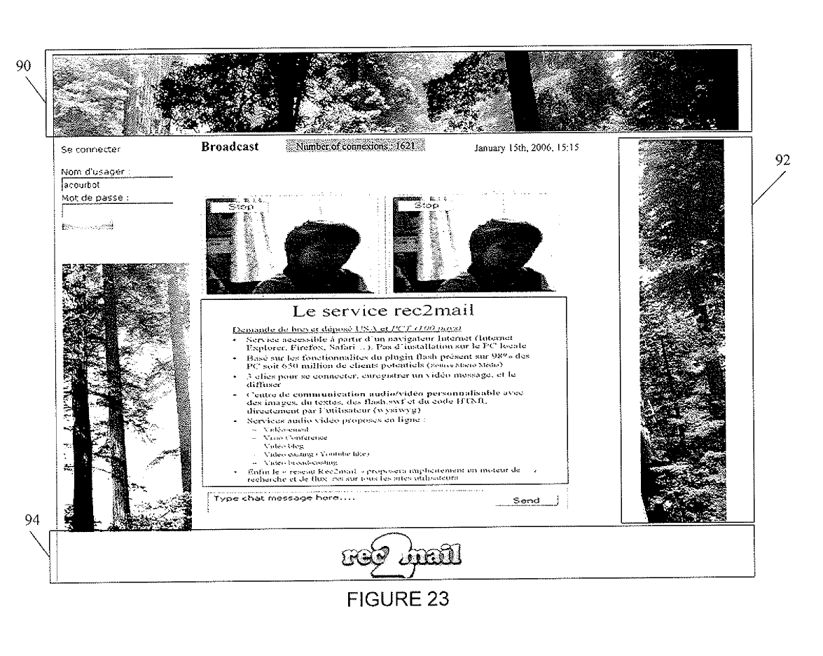

The broadcast is performed when the owner of the broadcast start the broadcast, which is performed by pressing the “start broadcast” button in one embodiment. A channel of communication is then open, as for the video chat, between the owner of the broadcast and the plurality of users invited. The public user webspace used for the video broadcast may be fully customized as shown in FIG. 23.

According to step 201, a plurality of users is invited for the video broadcast. The skilled addressee will appreciate that the plurality of users may be invited using various schemes such as using a notifying email sent to a plurality of users. The notifying email may comprise a plurality of information data related to the video broadcast such as a link for accessing a video broadcast webspace used for the video broadcast, an indication of the temporal location for the video broadcast or the like. When the broadcast starts, a flag may be activated in the public user webspace used for the broadcast, not shown in FIG. 7.

According to step 204, the video broadcast is performed. The video broadcast is started by the user by clicking on a corresponding button.

Each of the attending users may join the video broadcast by accessing the video broadcast webspace chosen for hosting the video broadcast. It will be further appreciated that the video broadcast webspace may be advantageously customized. In one embodiment, each of the attending users may interact with the user performing the video broadcast user text messaging.

In fact, the skilled addressee will appreciate that while in the embodiment of the video chat disclosed in FIG. 19, the number of attendees is limited (due to the size required for each video window) and predetermined, the number of users assisting to a video broadcast may not be limited to a given number and furthermore may be undefined.

The skilled addressee will appreciate that the embodiment disclosed in exemplary and that various other embodiments may be provided.

It will be appreciated that a computer readable memory adapted to store instructions which when executed create the cross-platform web interface disclosed may be provided.

The skilled addressee will also appreciate that various kinds of commercialization may be achieved. For instance, the embodiment disclosed may be provided as an Intranet application. Alternatively, the application may be provided as a website application. The interface may be offered in booths and mobile equipments. Also the cross-platform web interface may be used for private as well as for public sites security. The cross-platform web interface may also be used for survey support, online training, polls or the like. In fact, it will be appreciated that the method for communicating with the at least one selected user using may be done for a fee in one embodiment.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present invention can be carried out as a method, can be embodied in a system, a computer readable medium or an electrical or electro-magnetical signal.

We claim:

1. A method for communicating with at least one user using video via a data network, said method comprising:
accessing a user web interface;
customizing said web interface; and
communicating with said least one user using video in said customized web interface.

2. The method as claimed in claim 1, wherein said communicating with said at least one user comprises providing a video in said customized web interface, said video having a given format, generating a customized video message comprising at least said provided video and delivering said generated customized video message to said at least one user via said data network.

3. The method as claimed in claim 2, wherein said delivering of said generated customized video message comprises sending an email to each of said at least one user.

4. The method as claimed in claim 3, wherein said email is a notifying email comprising a link to a webspace hosting said generated customized video message.

5. The method as claimed in claim 4, wherein said webspace hosting said customized video message is also customized.

6. The method as claimed in claim 3, wherein said email comprises said video message.

7. The method as claimed in claim 2, wherein said delivering of said generated customized video message comprises posting said video message on a public user webspace.

8. The method as claimed in claim 7, wherein said public user webspace is customized.

9. The method as claimed in claim 1, wherein said communicating comprises inviting said at least one user to a videoconference and performing said videoconference with the invited at least one user.

10. The method as claimed in claim 9, wherein said inviting comprises sending a notifying email to said at least one user, said notifying email comprising information data related to said videoconference.

11. The method as claimed in claim 10, wherein said notifying email is sent by a user organizing the videoconference.

12. The method as claimed in claim 10, wherein said notifying email is sent automatically.

13. The method as claimed in claim 1, wherein said communicating comprises inviting a plurality of users to a video broadcast and performing the video broadcast.

14. The method as claimed in claim 13, further comprising preparing said video broadcast.

15. The method as claimed in claim 13, wherein said inviting said plurality of users to said video broadcast comprises sending a notifying email to said plurality of users comprising information data on said video broadcast.

16. The method as claimed in claim 15, wherein said information data comprises a link for accessing a customized video broadcast webspace used for said video broadcast and an indication of a temporal location for the video broadcast.

17. The method as claimed in claim 1, wherein said customizing of said web interface is performed by at least one of a user and an operator of said user web interface.

18. The method as claimed in claim 17, wherein said customization of said web interface is performed by said user, further wherein said customization comprises accessing a layout for said web interface, said layout comprising a plurality of banners and modifying at least one of said plurality of banners on said layout.

19. The method as claimed in claim 18, wherein said modifying of said at least one of said plurality of banners comprises for each banner selecting an image and using said selected image.

20. The method as claimed in claim 19, wherein said image is provided locally.

21. The method as claimed in claim 19, wherein said image is uploaded.

22. The method as claimed in claim 19, wherein said using of said selected image comprises interactively modifying said selected image.

23. The method as claimed in claim 19, wherein said modifying of said at least one of said plurality of banners comprises for each banner selecting dynamic data image and using said selected dynamic data.

24. A cross-platform web interface for communicating with at least one user using video via a data network, said interface comprising:
a user configurable videoconferencing module for performing a live video conference with said at least one user when said at least one user is available;
a user configurable video file converting module for uploading a local video file and converting the uploaded video file into a video file having a given video file format; and
a user configurable video email module for sending a link of said converted video file to said at least one user when said at least one user is not available.

25. The cross-platform web interface for communicating with at least one selected user as claimed in claim 24, wherein said user configurable video file converting module converts the uploaded video file onto a Flash video format.

26. The cross-platform web interface for communicating with at least one selected user as claimed in claim 24, wherein at least one of said user configurable videoconferencing module, said user configurable video file converting module and said user configurable video email module comprises at least one banner.

27. The cross-platform web interface as claimed in claim 24 wherein said given video file format is Flash format.

28. The cross-platform web interface for communicating with at least one selected user as claimed in claim 26, wherein said at least one banner is interactively created by said user.

29. A method of doing business wherein the method for communicating with at least one selected user using video via a data network as claimed in claim 1 is done for a fee.

30. A computer readable memory adapted to store instructions which when executed create the cross-platform web interface as claimed in claim 24.
